(19) United States
(12) Patent Application Publication
(10) Pub. No.: US 2004/0252687 A1
(43) Pub. Date: Dec. 16, 2004

(54) Method and process for scheduling data packet collection

(76) Inventors: Sridhar Lakshmanamurthy, Sunnyvale, CA (US); Prashant R. Chandra, Sunnyvale, CA (US); Wilson Y. Liao, Belmont, CA (US); Jeen-Yuan Miin, Palo Alto, CA (US); Yim Pun, Saratoga, CA (US); Chen-Chi Kuo, Pleasanton, CA (US); Jaroslaw J. Sydir, San Jose, CA (US)

Correspondence Address: FISH & RICHARDSON, PC, 12390 EL CAMINO REAL, SAN DIEGO, CA, 92130-2081, US

(21) Appl. No.: 10/463,231

(22) Filed: Jun. 16, 2003

(51) Int. Cl. H04L 12/28

(52) U.S. Cl. 370/389; 370/401

(57) ABSTRACT

A method executed in a computing device for scheduling data packet transfer, the method includes receiving a first and second bit, the first bit indicates if a first digital device is ready to transfer a first data packet, the second bit indicates if a second digital device is ready to transfer a second data packet, receiving a binary number that identifies the first bit, determining the first digital device is ready to transfer the first data packet based on the binary number identifying the first bit, and incrementing the binary number to identify the second bit.

### BACKGROUND

This application relates to a method and process for scheduling data packet collection. Communication systems, data processing systems, and so forth distribute data in packets for transmitting the data over a network such as a local area network (LAN), a wide area network (WAN), or other similar networking scheme. In some networking schemes a router receives data packets from computer systems connected to the router and sends the data packets for transmission in a stream of packets to another portion of the network. To balance distribution of the data packets collected from each of the computer systems, the router schedules a particular time for collecting a data packet from each computer system. However if the scheduled computer system has no data packet ready for transmission, the router rotates in a predetermined fashion to check the next scheduled computer system.

### DESCRIPTION OF DRAWINGS

FIG. 1 is a block diagram depicting a system for scheduling data packet collection.

FIG. 2 is a series of diagrams pictorially depicting bit-level register operations for scheduling data packet collection.

FIG. 3 is a flow chart of a data packet scheduler.

### DESCRIPTION

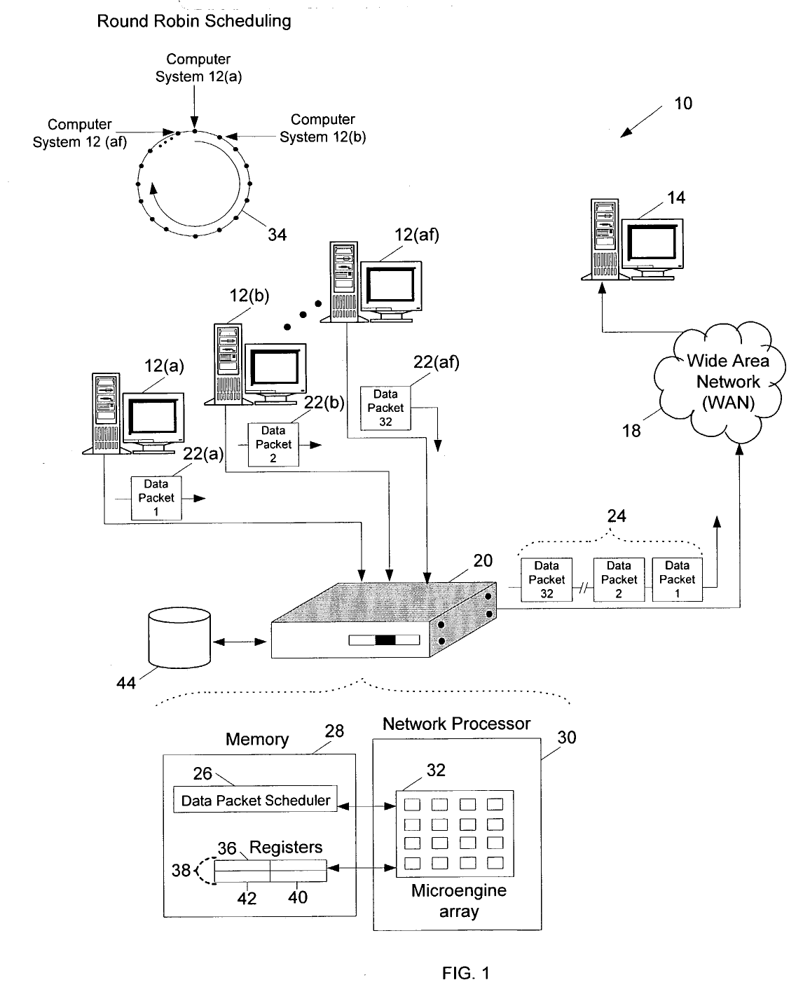

Referring to FIG. 1, a system 10 for transmitting data packets from a group of, e.g., thirty-two computer systems 12(a), 12(b), . . . , 12(af) to another computer system 14 through a wide area network (WAN) 18 includes a router 20 that respectively collects data packets 22(a), 22(b), . . . , 22(af) from each of the computer systems 12(a)-12(af) and groups the data packets into a data packet stream 24 for transmitting through the WAN 18 to the computer system 14. To produce the data packet stream 24, the router 20 includes a data packet scheduler 26 that is executed in memory 28 (e.g., ROM, RAM, SRAM, DRAM, etc.) by an array of, e.g., sixteen programmable multithreaded microengines 32 included in a network processor 30. However in other arrangements the data packet scheduler 26 is used with other processor architectures such as parallel architectures that use e.g., multiple processor cores on a single chip for data packet-level processing parallelism. In some arrangements, the data packet scheduler 26 is executed in memory included in the microengines of the microengine array 32. By executing the data packet scheduler 26, collection of data packets 22(a)-22(af) is scheduled such that the data packets are uniformly distributed in the data packet stream 24 transmitted from the router 20 to the computer system 14 through the WAN 18. In this particular arrangement, the router 20 collects data packets from thirty-two computer systems 12(a)-12(af), however, in other arrangements the router collects data packets from less than or more than thirty-two computer systems. Also, in some arrangements, the data packets 22(a)-22(af) are received from the respective computer systems 12(a)-12(af) by one or more Input/Output controller devices included in the router 20 that are used in the collection of data packets along with directing the data packets to one or more appropriate destinations. Alternatively for scheduling data packet collection from computer system 12(a)-12(af), in some arrangements the data packet scheduler 26 is used to schedule data packet collection from other digital devices such as a group of queues, storage devices, or other similar digital devices or in combination with the computer systems. For example, the data packet scheduler 26 is used to schedule data packet collection from queues included in the router 20. Additionally, in some arrangements memory 28 is located in the network processor 30.

The data packet scheduler 26 schedules collection of the data packets 22(a)-22(af). The data packet scheduler 26 monitors each of the computer systems 12(a)-12(af) in a rotation to determine if a data packet is ready for collection and insertion into the data packet stream 24. In some arrangements, the rotation used by the data packet scheduler 26 begins by first checking computer system 12(a), rotates to check computer system 12(b), and continues rotating to computer system 12(af). After checking computer system 12(af), the data packet scheduler 26 returns to check computer system 12(a) and repeats the rotation in a round robin fashion as represented by a round robin rotation wheel 34.

To determine if a data packet is ready for transmission from one of the computer systems 12(a)-12(af) in the rotation, the data packet scheduler 26 checks a status register 36 that is included in a group of registers 38 resident in the memory 28. In some arrangements one or more of the registers included in the group of registers 38 are included in memory (not shown) included of the microengines of the microengine array 32. The status register 36 stores bits that individually represent whether one of the computer systems 12(a)-12(af) has at least one data packet ready for transfer to the router 20 for insertion in the data packet stream 24. Additionally, the group of registers 38 includes a start position register 40 that stores a binary number that identifies a particular bit in the status register 36 to start checking based on the round robin rotation represented by the wheel 34. In this particular example, the group of registers 38 also includes a transmit register 42 that stores a binary number that identifies the computer system that has a data packet ready for transfer and is scheduled to transfer the data packet to the router 20 based on the round robin rotation. However, in some arrangements the start position register 40 provides the binary number that identifies the computer system along with providing the functionality of the transmit register 42. In some such alternatives the transmit register 42 is not used or, for example, serves as an alias of the start position register 40.

To schedule the round robin rotation and to determine whether the scheduled computer system has a data packet ready for transfer, the data packet scheduler 26 executes instructions that are associated with an instruction set (e.g., a reduced instruction set computer (RISC) architecture) specifically used by the array of sixteen programmable multithreaded microengines 32 included in the network processor 30. Since the instruction set is designed for specific use by the array of microengines 32, instructions are processed relatively quickly in fewer clock cycles than typically needed to execute instructions associated with a general-purpose processor. Each one of the microengines (e.g., a RISC processor that does not execute particular operations such as an integer division, etc.) included in the array of microengines 32 has a relatively simple architecture and quickly executes relatively routine processes (e.g., forwarding, converting, etc.) while leaving more complicated processing (e.g., routing table maintenance) to other processing units (not shown) included in the network processor 30 (e.g., StrongArm processor). Further, in some arrangements the data packet scheduler 26 instructions are written in microcode (e.g., machine code), or other similar code language, for specific execution by the array of microengines 32.

In system 10 the data packet scheduler 26 is executed in the memory 28 by the array of microengines 32 included in the network processor 30 included in the router 20. However, in some arrangements the data packet scheduler 26 is executed on an application-specific integrated circuit (ASIC), a microprocessor, or other similar processing device. Further, in some arrangements, the data packet scheduler 26 is executed on a network interface card (NIC), a line card, a computer system, or other similar data processing device. Also, in some arrangements the data packet scheduler 26 is stored on a storage device (e.g., a hard drive, CR-ROM, etc.) such as storage device 44 that is in communication with the router 20 and stores processes (e.g., a data packet stream production process) associated with the router, one or more of the computer systems 12(a)-12(af), or other similar device associated with system 10. By storing the data packet scheduler 26 on the storage device 44, the data packet scheduler is loaded into memory 28 at an appropriate time.

The data packet scheduler 26 determines if each of the computer systems 12(a)-12(af) is ready to transfer a data packet based on the round robin rotation. Also, while the data packet scheduler 26 uses a round robin rotation to schedule data packet collection from the thirty-two computer systems 12(a)-12(af), in some arrangements the data packet scheduler uses a deficit round robin rotation, a weighted round robin rotation, or other similar scheduling scheme to schedule data packet collection. Since this particular example schedules data packet collection from thirty-two computer systems 12(a)-12(af), the status register 36 is typically thirty-two bits wide so that one bit included in the status register individually represents the status of one of the thirty-two computer systems. However, in other arrangements more than or less than thirty-two computer systems are scheduled to for delivering data packets by the data packet scheduler 26. Also, in some arrangements status register 36 is more than or less than thirty-two bits wide for representing the status of each computer system.

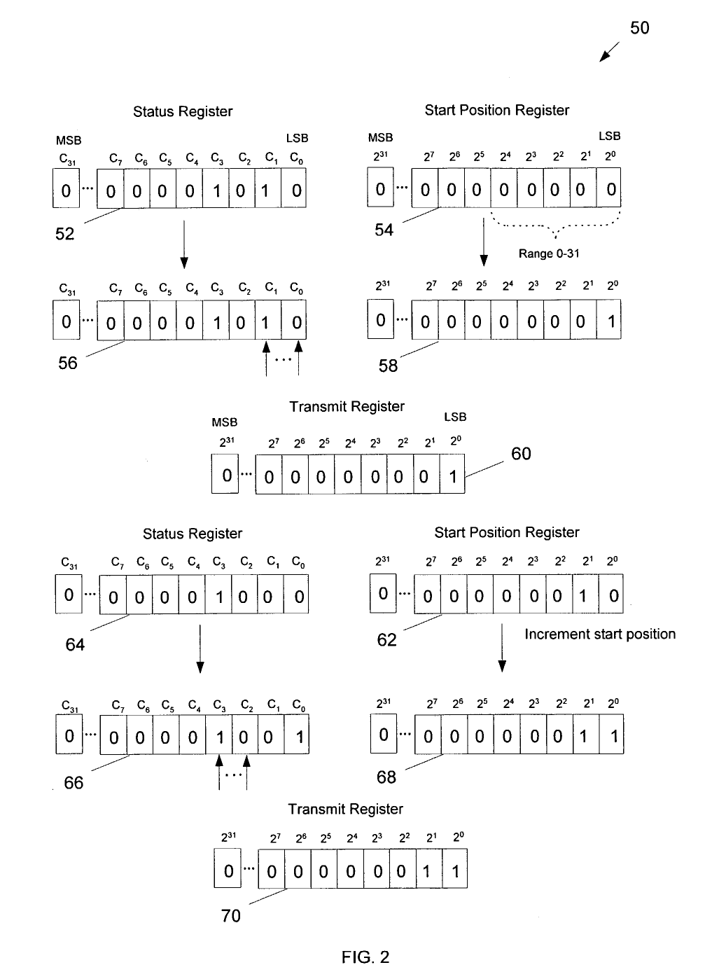

Referring to FIG. 2, a series of bit-level register operations 50 used by data packet scheduler 26 to schedule data packet collection in the round robin rotation from the thirty-two computer systems 12(a)-12(af) (FIG. 1) is shown. To initiate the scheduling and data packet collecting, a 32-bit wide status register 52 stores thirty-two bits (i.e., C₀-C₃₁) that indicate if a corresponding one of the computer systems has at least one data packet ready for transfer to the router 20. In this arrangement, the least significant bit (LBS) (i.e., Co) included in the status register 52 indicates if computer 12(a) is ready to transfer a data packet and the most-significant bit (MSB) (i.e., C₃₁) indicates if the computer 12(af) is ready to transmit a data packet. In this arrangement to indicate if one of the computer systems 12(a)-12(af) is ready to transfer a data packet, the respective bit in the status register 52 stores a logic level “1”. Alternatively, if one of the thirty-two computer systems 12(a)-12(af) does not have a data packet ready for transfer, the respective bit stores a logic level “0”. In this particular example, bits C₁ and C₃ store a logic level 1 to indicate that respective computer systems 12(b) and 12(d) are ready to transfer a data packet to the router 20.

Based on round robin rotation represented by the wheel 34, computer 12(a) is scheduled first to be checked to determine if a data packet (i.e., data packet 22(a)) is ready for transfer. To determine the status of computer system 12 (a), bit Co included in the status register 52 is checked. To determine that bit C₀ is the first bit to check, the data packet scheduler 26 accesses a binary number stored in a start position register 54 that represents the next bit in the status register 52 to check based on the round robin rotation. In this example, the start position register 54 stores a binary number equivalent to decimal “0” that identifies bit Co as the first bit to check. As indicated in status register 56, since the data packet scheduler 26 determines that bit C₀ stores a logic level “0,” the computer system 12(a) is not ready to transfer a data packet. Since computer system 12(a) is not ready, the data packet scheduler 26 determines if the next computer system (i.e., computer system 12(b)) in the rotation is ready to transfer a data packet. As indicated in status register 56, bit C1, which stores the status of computer system 12(b), is next examined by the data packet scheduler 26. In this example, bit C₁ stores a logic level “1” that indicates that computer 12(b) is ready to transfer a data packet. Since computer system 12(b) is ready to transfer a data packet, the data packet scheduler 26 stores a binary number with a decimal equivalent of “1” in a start position register 58 to indicate that computer 12(b) is the first computer system in the rotation ready to transfer a data packet. Also, the binary number with a decimal equivalent of “1” is stored in a transmit register 60 that is used by the router 20 to identify the computer system 12(b) for collecting a data packet. However, as mentioned, in some arrangements the start position register 58 is used by the router 20 to identify the computer system 12(b).

In this particular example, the start position register 54 stores the binary number with decimal equivalent of “0” to indicate that the round robin rotation starts with computer system 12(a). However, in other examples, the start position register 54 stores another binary number (e.g., with decimal equivalent of “1”) to represent another computer system (e.g., computer system 12(b)) to start the round robin rotation. Also, since thirty-two computer systems (i.e., computer systems 12(a)-12(af)) are used in the rotation, five bits (i.e., bits 20-24) starting with the LSB in the start position register 54 are used to identify each of the thirty-two bits (i.e., bit C₀-C₃₁) in the status register 52 and correspondingly the associated computer systems. Specifically a binary number with a decimal equivalent of “0” represents computer system 12(a) and corresponding status bit C₀ in the status register 52 and binary number “11111” with decimal equivalent “31” represents the thirty-second computer system 12(af) and corresponding status bit C₃₁ in the status register 52. So by using five bits, binary numbers with decimal equivalents ranging from “0” to “31” are stored in the start position registers 54, 58 and the transmit register 60 to identify any of the thirty-two computer systems 12(a)-12(af) and the respective bits C₀-C₃₁ included in the status register 52.

After the transmit register 60 is provided the binary number identifying the computer system (e.g., computer system 12(b)) ready to transfer a data packet, the data packet is collected by the router 20. Additionally, the data packet scheduler 26 continues to determine the next computer system ready to transfer a data packet based on the round robin rotation. To determine the next computer system, similar bit level operations are performed by the data packet scheduler 26. However, prior to repeating the bit level operations, the binary number stored in the start position register 58 is incremented by 1 to identify the next computer system in the round robin rotation. In this particular example the binary number (i.e., decimal equivalent of “1”) stored in start position register 58 is incremented by 1 and the resulting binary number (i.e., decimal equivalent 2) so stored in start position register 62.

By incrementing the binary number identifying that last computer system (i.e., computer system 12(b)) that transferred a data packet to the router 20, the next computer system scheduled in the round robin rotation is relatively quickly determined. To determine if the next computer system is ready to transfer a data packet, a status register 64 stores thirty-two bits (i.e., C₀-C₃₁) that identifies the status of each of the thirty-two computer systems 12(a)-12(af). In this example, only computer system 12(d) has a data packet ready for transfer as indicated by the logic level “1” stored in bit C₃ of the status register 64. Also, due to the incrementing, the binary number with decimal equivalent of “2” stored in the start position register 62 indicates that the data packet scheduler 26 now start checking with bit C₂ in the status register 64. In this particular example, the C₂ bit stores a logic level “0” that represents that computer system 12(c) does not have a data packet ready for transfer. The data packet scheduler 26 next checks the bit C3 associated with the next computer system (i.e., computer system 12(d)) in the round robin rotation. As indicated in status register 66, the data packet scheduler 26 determines from the logic level “1” stored in bit C₃ of the status register 66 that the computer system 12(d) has a data packet ready for transfer. Similar to computer system 12(b), to indicate that computer system 12(d) has a data packet ready for transfer, a binary number with decimal equivalent of “3” is stored in start position register 68. After the data packet is from computer system 12(d) is received by the router 20 and the data packet scheduler 26 continues the round robin rotation, this binary number stored in start position register 68 is incremented by 1 to identify the next bit (i.e., bit C₄) in the status register 66 to start checking the next computer system (i.e., computer system 12(e)) in the round robin rotation. Additionally the binary number with decimal equivalent of “3” is stored in transmit register 70 so that the router 20 identifies the next computer system (i.e., computer system 12(d)) ready to transfer a data packet.

Since the binary number stored in the start position register is incremented so that the data packet scheduler 26 rotates to check the next computer system in the round robin rotation, as the rotation continues, eventually the binary number stored in the start position register increments to a binary number with a decimal equivalent of “31” (i.e., binary number 11111) to represent that computer system 12(af) be checked next. After computer system 12(af) is checked the binary number with decimal equivalent “31” is incremented to a binary number (i.e., 100000) with a decimal equivalent of “32”. The decimal equivalent (i.e., “32”) of this six-bit binary number (i.e., 100000) is not equivalent to decimal “0” that identifies the computer system 12(a) to repeat the round robin rotation. However, by using the decimal equivalent of the first five-bits (i.e., bit 2⁰-bit 2⁴) of the binary number stored in the start position register, the five-bit number (i.e., 00000) with decimal equivalent of “0” represents computer system 12(a) and returns to the start of the round robin rotation. Furthermore, by using the first five-bits (i.e., bit 2⁰-bit 2⁴) of the start position register, the round robin rotation continues indefinitely since by incrementing the binary number stored in the start position register, the next computer system of the thirty-two computers is identified along with the next bit to check in the status register. Also, by using the first five bits, in this example only these five bits need to be initially set to a logic level “0” since the logic level of the remaining twenty-seven bits are not used to track the rotation.

By incrementing the binary number stored in the start position register to rotate through the thirty-two computer systems 12(a)-12(ah) in a round robin fashion, a single incrementing instruction is executed to determine the next computer system to be checked for a data packet ready for transfer. Compared to executing multiple instructions, by using a single incrementing instruction to determine the next computer system in the round robin rotation, the data packet scheduler 26 uses less clock cycles. By using less clock cycles, clock cycles are conserved and provided to the network processor 30 for budgeting in other operations (e.g., error checking, transferring binary numbers, etc.) and for increasing efficiency of the network processor.

In some arrangements the data packet scheduler 26 is executed by the array of microengines 32 by executing a series of arithmetic-logic unit (ALU) instructions. The ALU executed instructions include identifying the next computer system ready to transfer a data packet, transferring the data packet from the computer system, and incrementing a binary number to identify the next computer system in the round robin rotation. For example, the series of ALU instructions include an ALU instruction that uses a binary number stored in a start position register (e.g., start position register 54) to identify a starting bit to begin checking a status register (e.g., status register 52). A find-first-bit (FFB) routine identified in the ALU instruction uses the identified starting bit to find the first bit in the status register that stores a logic level “1” to represent that an associated computer system is ready to transfer a data packet. Once the bit storing the logic level “1” in the status register is found, a binary number identifying the associated computer system is stored by the ALU instruction in a transmit register (e.g., transmit register 60). One exemplary ALU instruction that performs this operation is:

Alu(transmit register, start position register, ffb, status register). (1)

Alternatively, if the start position register is used to identify the computer system, one exemplary ALU instruction that performs this operation is:

Alu(start position register, start position register, ffb, status register). (1A)

After the binary number identifying the computer system is stored in the transmit register, another ALU instruction included in the series uses the binary number in the transmit register to retrieve the data packet from the identified computer system. One exemplary ALU instruction that performs this operation is:

SetupQueueGroupStruct(transmit register). (2)

Based on the alternative associated with the ALU instruction (1A), if the start position register is used to identify the computer system, one exemplary ALU instruction that performs this operation is:

SetupQueueGroupStruct(start position register). (2A)

After the data packet is received, the round robin rotation to check the computer systems continues by incrementing the binary number stored in the start position register so that the FFB routine uses a starting bit in the status register that corresponds to the next computer system in the round robin rotation. One exemplary ALU instruction that performs the incrementing operation is:

Alu(start position register, transmit register, +, 1). (3)

Based on the alternative associated with the ALU instruction (1A) and (2A), if the start position register is used to identify the computer system, one exemplary ALU instruction that performs this operation is:

Alu(start position register, start position register, +, 1). (3A)

After the binary number in the start position register is incremented, the ALU instruction (1) is repeated to continue checking of the computer systems in the round robin rotation for a data packet ready for transfer. Instructions (1)-(3A) are presented in one particular syntax, however, in other arrangements, the instructions are written in another type of syntax. In some arrangements the operations of the data packet scheduler 26 is written in source code with e.g., “higher-level” languages such as COBOL, FORTRAN, C, etc. or with “lower-level” assembly language. The respective “higher-level” source code is then typically complied with a complier or the respective “lower-level” source code is typically assembled with an assembler into an object program or machine code that is executed to perform the operations of the data packet scheduler 26.

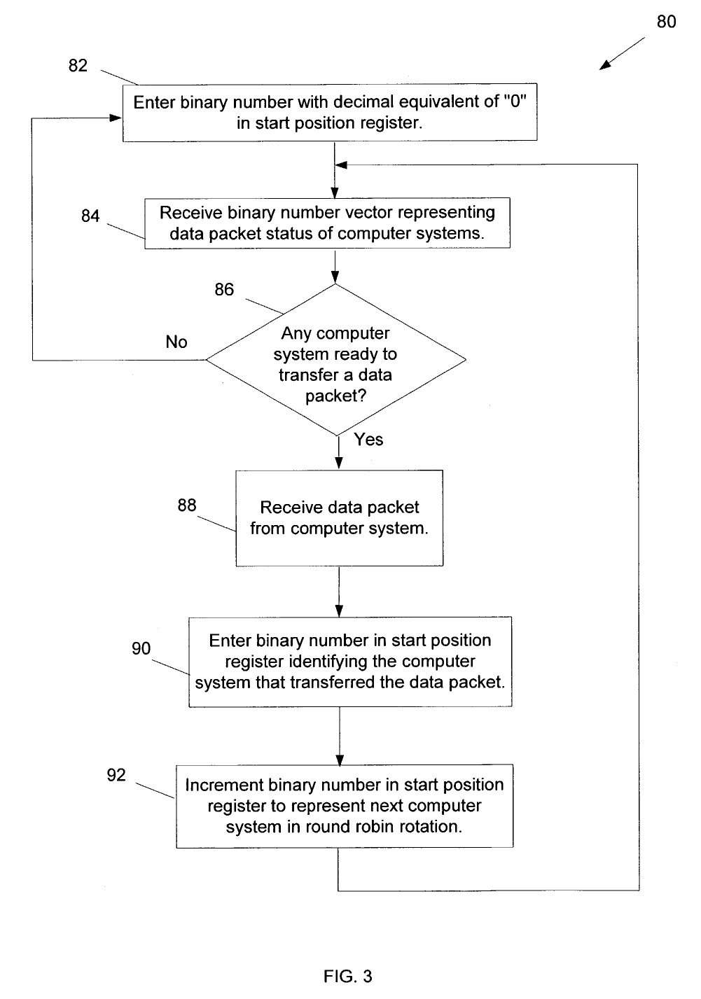

Referring to FIG. 3, a generalized description of a data packet scheduler 80 includes 82 entering a binary number with decimal equivalent of “0” in a start position register, such as start position register 54 (shown in FIG. 2), to represent the first computer system (e.g., computer system 12(a)) being checked in a round robin rotation for a data packet ready for transfer. However in some arrangements a binary number with a decimal equivalent other than “0” is entered into the start position register to represent another computer system (e.g., computer system 12(b)) being checked first for a data packet ready for transfer. After entering 82 the binary number with decimal equivalent of “0”, the data packet scheduler 80 receives 84 a binary number vector that includes bits that individually represent if a particular computer system (e.g., computer system 12(a)-12(af)) has at least one data packet ready for transfer. In some arrangements the binary number vector is stored in a status register such as the status register 52 (shown in FIG. 2). After receiving 84 the binary number vector, the data packet scheduler 80 determines 86 from the binary number vector if a data packet is ready for transfer from one of computer systems. Starting with the respective bit, included the binary number vector, which is identified by the binary number stored in the start position register, the data packet scheduler 80 determines if the associated computer system (i.e., computer system 12(a)) has a data packet ready for transfer. If the computer system does not have a data packet ready for transfer, the other bits included in the binary number vector are consecutively checked based on the round robin rotation until the next computer system that has a data packet ready for transfer is determined. If determined that none of the computer systems have a data packet ready for transfer, the data packet scheduler 80 enters 82 a binary number with decimal equivalent of “0” in the start position register and the data packet scheduler 80 continues.

If determined that one of the computer systems has a data packet ready for transfer, the data packet scheduler 80 receives 88 the data packet from the identified computer system. After receiving 88 the data packet, the data packet scheduler 80 enters 90 a binary number into the start position register that identifies the computer system that transferred the data packet. After entering 90 the binary number in the start position register, the data packet scheduler 80 increments 92 the binary number stored in the start position register such that the incremented binary number represents the next computer system in the round robin rotation. After incrementing 92 the binary number in the start position register, the data packet scheduler 80 returns to receive a binary number vector representing the status of each computer system for determining the next computer system ready to transfer a data packet. Since the binary number stored in the start position register is incremented, upon returning, the data packet scheduler 80 determines if a data packet is ready for transfer starting with the next computer system in the round robin rotation.

The processes described herein can be implemented in digital electronic circuitry, or in computer hardware, firmware, software, or in combinations of them. The processes described herein can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Methods can be performed by one or more programmable processors executing a computer program to operate on input data and generate output. The method can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The processes described herein can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The processes described herein can also be implemented in other electronic devices individually or in combination with a computer or computer system. For example, the processes can be implemented on mobile devices (e.g., cellular phones, personal digital assistants, etc.).

The invention has been described in terms of particular embodiments. Other embodiments are within the scope of the following claims. In some arrangements the data packet scheduler 26 is used to schedule data packet collection from a group of registers, queues, processors, or other similar digital storage or processing devices such as a group of personal digital assistants (PDA's), cellular telephones, or other similar group of digital devices. Also, portions of the methods can be performed in a different order and still achieve desirable results.

What is claimed is:

1. A method executed in a computing device for scheduling data packet collection, the method comprising:
receiving a first and second bit, the first bit indicates if a first digital device is ready to transfer a first data packet, the second bit indicates if a second digital device is ready to transfer a second data packet;
determining the first digital device is ready to transfer the first data packet based on a binary number that identifies the first bit; and
incrementing the binary number to identify the second bit.

2. The method of claim 1, further comprising:
receiving the first data packet from the first digital device.

3. The method of claim 1, further comprising:
determining the second digital device is ready to transfer the second data packet based on the binary number identifying the second bit.

4. The method of claim 1, wherein the first bit and the second bit reside in a status register.

5. The method of claim 1, wherein the binary number resides in a start position register.

6. The method of claim 1, wherein the first bit and the binary number reside in a shared register stack accessible by different computing devices.

7. The method of claim 1, wherein the first bit and the second bit reside in a status register.

8. The method of claim 1, wherein the first digital device includes a queue that stores the first data packet.

9. A computer program product, tangibly embodied in an information carrier, for scheduling data packet collection, the computer program product being operable to cause a machine to:
receive a first and second bit, the first bit indicates if a first digital device is ready to transfer a first data packet, the second bit indicates if a second digital device is ready to transfer a second data packet;
determine the first digital device is ready to transfer the first data packet based on a binary number that identifies the first bit; and
increment the binary number to identify the second bit.

10. The computer program product of claim 9 being further operable to cause a machine to:
receive the first data packet from the first digital device.

11. The computer program product of claim 9 being further operable to cause a machine to:
determine the second digital device is ready to transfer the second data packet based on the binary number identifying the second bit.

12. The computer program product of claim 9, wherein the first bit and the second bit reside in a status register.

13. The computer program product of claim 9, wherein the binary number resides in a start position register.

14. The computer program product of claim 9, wherein the first bit and the binary number reside in a shared register stack accessible by different computing devices.

15. The computer program product of claim 9, wherein the first bit and the second bit reside in a status register.

16. The computer program product of claim 9, wherein the first digital device includes a queue that stores the first data packet.

17. A data packet scheduler device comprises:
a receiving process to receive first and second bits, the first bit indicating if a first digital device is ready to transfer a first data packet, the second bit indicating if a second digital device is ready to transfer a second data packet;
a determining process to determine whether the first digital device is ready to transfer the first data packet based on a binary number that identifies the first bit; and
an incrementing process to increment the binary number to identify the second bit.

18. The data packet scheduler of claim 17, further comprising:
a second receiving process to receive the first data packet from the first digital device.

19. The data packet scheduler of claim 17, further comprising:
a second determining process to determine the second digital device is ready to transfer the second data packet based on the binary number identifying the second bit.

20. The data packet scheduler of claim 17, wherein the first bit and the second bit reside in a status register.

21. The data packet scheduler of claim 17, wherein the binary number resides in a start position register.

22. The data packet scheduler of claim 17, wherein the first bit and the binary number reside in a shared register stack accessible by different computing devices.

23. The data packet scheduler of claim 17, wherein the first bit and the second bit reside in a status register.

24. The data packet scheduler of claim 17, wherein the first digital device includes a queue that stores the first data packet.

25. A system comprising a processor capable of:
receiving a first and second bit, the first bit indicates if a first digital device is ready to transfer a first data packet, the second bit indicates if a second digital device is ready to transfer a second data packet;
determining the first digital device is ready to transfer the first data packet based on a binary number that identifies the first bit; and
incrementing the binary number to identify the second bit.

26. The system of claim 25, wherein the processor is further capable of receiving the first data packet from the first digital device.

27. The system of claim 25, wherein the processor is further capable of determining the second digital device is ready to transfer the second data packet based on the binary number identifying the second bit.

28. The system of claim 25, wherein the first bit and the second bit reside in a status register.

29. A system comprising:
an Input/Output controller device capable of receiving a first and second data packet; and
a processor capable of,
receiving a first and second bit, the first bit indicates if a first digital device is ready to transfer the first data packet, the second bit indicates if a second digital device is ready to transfer the second data packet,
determining the first digital device is ready to transfer the first data packet based on a binary number identifies the first bit, and
incrementing the binary number to identify the second bit.

30. The system of claim 29, wherein the Input/Output controller device is capable of receiving the first data packet from the first digital device.

31. The system of claim 29, wherein the processor is further capable of determining the second digital device is ready to transfer the second data packet based on the binary number identifying the second bit.

32. The system of claim 29, wherein the first bit and the second bit reside in a status register.

33. The system of claim 29, wherein the processor includes a microengine.

34. An assembler capable of receiving source code that includes instructions for scheduling data packet collection, the source code being operable to cause a machine to:
receive a first and second bit, the first bit indicates if a first digital device is ready to transfer a first data packet, the second bit indicates if a second digital device is ready to transfer a second data packet;
determine the first digital device is ready to transfer the first data packet based on a binary number that identifies the first bit; and
increment the binary number to identify the second bit.

35. The assembler of claim 34 wherein the source code being further operable to cause a machine to:
receive the first data packet from the first digital device.

36. The assembler of claim 34 wherein the source code being further operable to cause a machine to:
determine the second digital device is ready to transfer the second data packet based on the binary number identifying the second bi
